(19) United States
(12) Patent Application Publication
(10) Pub. No.: US 2018/0169888 A1
(43) Pub. Date: Jun. 21, 2018

(54) Slicing Apparatus

(71) Applicant: Weber Maschinenbau GmbH, Breidenbach (DE)

(72) Inventor: Tobias Weber, Biedenkopf (DE)

(73) Assignee: Weber Maschinenbau GmbH, Breidenbach (DE)

(21) Appl. No.: 15/735,310

(22) PCT Filed: Jun. 14, 2016
(86) PCT No.: PCT/EP2016/063547

§ 371 Date: Dec. 11, 2017

(30) Foreign Application Priority Data
Jun. 16, 2015 (DE) 10 2015 109 633.1

(51) Int. Cl. B26D 7/32; B26D 7/06; B65B 25/06

(52) U.S. Cl. CPC B26D 7/32; B26D 2007/0018; B65B 25/06; B26D 7/0616

(57) ABSTRACT

The invention relates to an apparatus, in particular a high-speed slicer, for slicing food products into portions comprising at least one slice, having a slicing unit which is configured to separate slices from a product, wherein, in a cutting region, the slices drop, as a stream of slices, directly onto at least one carrier and form a portion on the carrier, having a moving apparatus for moving the carrier laden with portions out of the cutting region, having an introduction apparatus which is configured to introduce at least one further carrier into the stream of slices as soon as a portion has been formed on a preceding carrier, and having at least one control device for controlling the movements of the carriers, the slicing unit and/or the introduction apparatus.

The invention relates to an apparatus, in particular to a high-speed slicer, for slicing food products into portions comprising at least one slice. The food products can, for example, be sausage, ham, meat, cheese or the like.

The slicing apparatus comprises a slicing unit that is configured to cut slices from a product. The slicing unit can be a cutting blade, in particular a scythe-like blade or a circular blade, revolving in a rotating manner and/or in planetary motion.

With conventional slicing apparatus, the cut-off slices fall onto a conveyor belt, e.g. a portioning belt, and form a portion there. A specific time period during which no slices are cut from the product is required to be able to transport the portion away. The product feed is stopped for this purpose. However, this has the disadvantage that the product may expand and project into the region of the cutting plane. This may have the result that the slicing unit cuts product scraps or product snippets from the product. These product scraps or product snippets reach the completed portions and impair the visual appearance. So-called blank cuts have previously been carried out to avoid this problem. The supplied product is here, for example, moved back against the conveying direction out of the cutting plane and/or the slicing unit is moved away from the cutting plane. A contact between the product and the slicing unit is prevented in this manner. The slicing unit carries out a normal cutting movement during the blank cuts, but without cutting slices from the product.

It is disadvantageous with these blanks cuts that they cost time and the throughout is thus reduced. A certain mechanical effort is additionally required for this purpose.

Slicing apparatus are known from the prior art in which portions can be formed and transported away without carrying out blank cuts.

In accordance with DE 197 13 813 C1, slices are cut onto a stack receiver. The latter transfers a partly completed stack to a portioning belt. The incomplete stack is completed on the portioning belt by further slices. Once the stack is complete, the stack receiver intervenes in the slice stream so that a further stack can be prepared on the stack receiver. The complete stack can be transported away in the meantime.

DE 10 2010 060 325 A1 describes a similar principle. A buffer store is channeled in for this purpose and a portion is prepared on it. The still incomplete portion is transferred to a conveying device and is completed there.

In accordance with the prior art, a stack receiver or a buffer store is always required to intervene in the slice stream. This requires a complex and/or expensive control and mechanism.

It is an object of the invention to provide an apparatus and a method for slicing food products that ensures a high throughput in the manufacture of portions in a simple and inexpensive manner.

This object is satisfied by an apparatus and by a method having the features of the respective independent claims.

In accordance with the invention, the slices fall directly onto at least one carrier as a slice stream in a cutting region and form a portion on the carrier.

The carrier can in particular be a rigid portion carrier. It can remain associated with a portion and can, for example, be transported together. The carrier can consequently e.g. serve as a tray for the portion. A conventional conveyor belt that transports portions does not correspond to a carrier in the sense of the present invention, particularly since the carrier itself is transported in the present case.

If, in accordance with a possible embodiment that will be explained in more detail in the following, an obstacle is provided in the falling path of the slices so that the falling slices interact with the obstacle before they fall onto the carrier, a direct falling of the slices onto the carrier is likewise to be understood by this.

An obstacle for influencing the slices can be arranged in the falling path of the slices, preferably at the slicing apparatus. It can be a rigid obstacle such as a simple bar or a moving obstacle such as a continuous belt that is in particular relatively short and that preferably revolves at a relatively high speed. A modified placement of the slicers on the product placement area can be achieved by influencing the slices or their falling movement. The slices can in particular be placed down in a folded, folded-over or compressed manner, which is desired in certain applications. So-called “shaved meat” portions can specifically be formed from compressed slices.

On the one hand, a portion is to be understood as a complete portion that can be packaged in this form. On the other hand, a part portion is also included that can, for example, have a predefinable number of slices or a predefinable weight. It is generally also possible that a portion only comprises a single slice.

The portions are in particular compiled on the carrier. The individual slices can be stacked or formed in an overlapping manner on the carrier.

The slicing apparatus comprises a movement apparatus for moving the carriers loaded with portions out of the cutting region. The carriers can be moved together with the portions to a processing apparatus, for example a packaging apparatus, connected downstream. The portions can also be buffered, sorted and/or handled, in particular rotated or overlapped. Only good portions are preferably transferred to the packaging apparatus at the end of the movement apparatus.

The slicing apparatus furthermore has an introduction apparatus that is configured to introduce at least one further carrier into the slice stream as soon as a portion has been formed on the preceding carrier. The carrier can in particular be empty on the introduction. It is alternatively also possible that the carrier already has some slices, in particular of a different kind. Mixed portions, that is portions having slices of different kinds, can thus be prepared, for example. If, for example, a part portion has been prepared with a desired number of slices of one kind, the carrier having the part portion can be transported to a further slicing unit and can there be introduced into the corresponding slice stream to receive slices of a different kind. The same principle also applies to slices of the same kind. A part portion can thus also be moved to a further slicing unit to be completed there.

A further carrier for a subsequent portion can consequently be introduced into the slice stream as soon as the preceding portion has been completely prepared on a preceding carrier or has a desired number of slices, with mixed portions for example.

The slicing apparatus comprises at least one control device for controlling the movement of the carriers, the slicing unit and/or the introduction apparatus. It is possible in this respect that a single control controls all the routines. Alternatively, respective separate control apparatus can also be provided for the carriers, for the slicing unit and/or for the introduction apparatus.

The portioning in particular does not take place on a portioning belt, as usual in the field, but rather directly on the carrier. The carrier is introduced into the cutting region for this purpose to receive the cut off slices. These slices fall directly onto the carrier, i.e. a stack receiver that is complex from a mechanical and technical control aspect or a buffer store is not required. The slices in particular only fall onto the carrier. The slices are transported onward on the same carrier. The formed portions are not displaced in this process since no further transfer of portions is required, e.g. from a stack receiver or a buffer store onto the carrier or from a portioning belt to a subsequent conveyor belt.

Nor does the slicing operation have to be interrupted for the transporting away of the portions since the carrier is introduced quickly between the falling slices. The throughput is thereby increased in a simple and inexpensive manner. Belts and belt distances can furthermore be minimized.

Further developments of the invention can also be seen from the dependent claims, the description and the enclosed drawings.

In accordance with an embodiment, the slicing unit is configured to cut slices from a product continuously, with the slice stream being continuous. Slices in particular fall down permanently. The slice stream is consequently not interrupted during the slicing of a product, e.g. to transport the portions away, so that the throughput and thus the number of prepared portions per time unit can be considerably increased.

In accordance with a further embodiment, the movement apparatus comprises a plurality of individually movable transport movers and a path system for the transport movers in which the transport movers are movable along at least one predefined path in a transporting away direction, with the transport movers in particular each comprising at least one runner cooperating with the path system and a holding device for receiving at least one carrier at the runner.

The holding device of the transport mover can preferably be configured for receiving a plurality of carriers, in particular two carriers. The carriers can in particular be introduced into slice streams running next to one another and be loaded with slices simultaneously in a multitrack operation. The carriers can subsequently be moved out of the cutting region by a common transport mover. With two carriers, they can preferably be arranged at sides of the transport mover different with respect to the runner in the held state.

The drive for the transport movers can, for example, be formed as a linear motor, in particular as a linear synchronous motor or as a linear induction motor.

Such linear motors are generally known in connection with a plurality of applications. Such a drive principle is inter alia advantageous when comparatively small loads are to be transported such as is the case in the sector of the transport of food products in question here.

A transport system which can generally be used for the invention and to which reference is explicitly made with respect to the requirement of performability of the invention is offered by the company MagneMotion, Inc., domiciled in Devens, Mass., USA. This system is based on a so-called LSM drive, that is on a drive by linear synchronous motors, which is to be distinguished from a so-called linear induction motor (LIM drive). Unlike an LIM drive, in an LSM drive, a magnetic field is not induced by means of the so-called electromagnetic traveling field, but the magnetic field is provided by permanent magnets. When the runner of the linear motor carries the permanent magnets and the stator of the linear motor produces the electromagnetic traveling field, the drive principle of an LSM drive can be figuratively imagined such that the transport mover provided with the permanent magnets is pulled over the transport line by the magnetic field moving along the stator. Such a transport system or drive principle is described, for example, in WO 2003/029651 A2 and WO 2010/085670 A1. Reference is herewith explicitly made to these documents with reference to the disclosure of a possible drive principle or function principle for the invention.

The path system or the individual paths of such a transport system can be divided into a plurality of consecutive path elements which so-to-say each form a single linear motor and can be individually controlled by a control device. If the transport movers located in the path system can be identified simultaneously by means of the control device, generally any desired number of transport movers can then be operated simultaneously in a path system of generally any desired complexity and can be individually moved in this respect.

The above-mentioned company MagneMotion, Inc. uses a technique for the identification and localization of the individual transporters in the path system in which each transporter mover is provided with a transducer which induces a signal in the stator formed by the path system, whereby it makes it possible for the control device to determine the exact position of the transport mover with an accuracy dependent on the size of the total system of fractions of a millimeter or fractions of a centimeter. An advantage of this system comprises no external sensors being required. In the control system of the company MagneMotion, Inc., it is additionally ensured by a division of the paths into a plurality of path elements—which so-to-say each represent a single linear motor—that no collisions occur between the transporter movers following one another. A transport mover can thus only travel into the next path element when it is permitted by the control device, which is in particular not the case when another transport mover is located in the path element.

Against the background of this generally known transport system, provision is made in a possible embodiment in the invention that the path system is configured as a stator of the linear motor.

The runner is in particular a respective component of a linear synchronous motor, with the runner in particular comprising at least one permanent magnet and the path system being configured as a motor stator.

The path system is preferably divided into a plurality of path elements which in particular each represent a single linear motor and which are individually controllable by the control device.

The transport movers are preferably identifiable by the control device.

The transport movers can furthermore preferably be localized in the path system by the control device.

The transport system has a plurality of transport movers whose total number depends on the respective application. Provision can be made that the path system comprises several dozen up to some hundred transport movers, i.e. a positive “cluster” of transport movers can be present in the path system to transport a plurality of portions and optionally to carry out additional functions such as a buffering, a distribution and/or an association of portions.

In accordance with a further embodiment, the control device controls the slicing unit such that no blank cuts are carried out.

A blank cut is typically carried out after the last slice of a portion, which can also be a part portion. The cut in the course of the next blade revolution thus cuts into nothing.

The fact that no blank cuts are now carried out means that a slice is immediately cut off again on the following blade revolution after the cutting off of the last slice of a portion. After the blade revolution for cutting the last slice of the preceding portion, the first slice of the following portion is thus cut off directly on the next blade revolution. The cut in the course of the next blade revolution therefore does not cut into nothing.

A single product is sliced continuously without interruption. An interruption only takes place on a product change, that is when a product has been completely sliced and a new product is subsequently sliced.

Breaks during slicing are minimized in accordance with the invention. This produces a continuous slice stream and accompanying it a continuous portion stream.

In accordance with a further embodiment, the control device controls the slicing unit such that the spacing between falling slices of a product is constant. The temporal and/or spatial intervals of the falling slices of a product in particular remains the same. The temporal interval can amount to a few fractions of a second, for example in an extreme case with a cutting performance of 2000 slices a minute, to only 30 milliseconds. However, larger temporal intervals are also conceivable. The temporal interval can in particular amount to at most, 40, 50, 75, 100, 200, 300, 400 or 500 milliseconds. The spatial interval can amount to a few centimeters or even only a few millimeters. The slicing unit consequently cuts slices from the product evenly at a constant speed. The interval between the falling slices also in particular does not change on the introduction of the carrier into the slice stream or on the transporting away of a portion. The carriers therefore have to be introduced quickly into the slice stream.

In accordance with a further embodiment, a transfer apparatus is provided that transfers the products from the carrier to a packaging apparatus. The portions can in particular first be moved on a carrier by the movement apparatus, in particular on a path system. The portion in this respect in particular remains on the carrier. In the region of a packaging apparatus, the transfer apparatus can transfer the portions into the packaging apparatus, in particular into a package. A robot unit, in particular having a picker, can in this respect serve as a transfer apparatus. The portion can thereby be transferred from the carrier into the package.

It is alternatively possible that the carrier already forms a part of a package. The carrier can thus, for example, be formed as a tray. The individual slices here fall directly into the tray. The tray is moved to the packaging apparatus and is finally packaged there, i.e. is in particular welded and/or adhesively bonded to a film.

It is also conceivable that a tray into which the cut off slices fall lies on a carrier and is moved as a unit with the carrier. The carrier can here have a holding apparatus, e.g. a frame, a recess and/or a cut-out, for the tray. The tray can then be transferred from the carrier to a packaging apparatus.

In accordance with a further embodiment, the portion remains on the carrier up to the transfer to a packaging apparatus. This in particular means that the slices that fall directly onto the carrier also remain on said carrier until the portions are packaged. The portions are consequently not displaced on the way to the packaging apparatus such as can be the case, for example, with conventional conveyor belt systems having belt transitions or slicing apparatus having a stack receiver or a buffer store in the slice stream.

In accordance with a further embodiment, two carriers are provided for each portion and complement one another to form a common support for the portion in the cutting region.

The support in this respect corresponds so-to-say to a divided carrier. The two carriers or carrier halves can in particular be introduced into the slice stream from different sides. This has the advantage that the respective carriers have to cover a smaller distance. The support can consequently be introduced faster into the slice stream overall than an individual carrier.

Provision can in particular also be made that two transport movers are used per portion. A separate transport mover can be associated with each carrier here. The two transport movers can preferably introduce the carriers into the slice stream from different sides.

In accordance with a further embodiment, the introduction apparatus comprises at least one holder that temporarily fixes or holds the carrier. The carrier can thus be securely held and/or positioned in the slice stream while the slices fall onto the carrier.

The holder can in particular hold the carrier mechanically, magnetically and/or hydraulically, e.g. by means of a generated vacuum. The holder preferably comprises a fork or a tongue.

In accordance with a further embodiment, the holder is configured to transfer the carrier loaded with a portion to the movement apparatus, in particular to a transport mover or to a holding device. Once a portion has been prepared on a carrier, the carrier can be released from the holder again. The carrier is in particular again out of engagement with the introduction apparatus so that it can be moved out of the cutting region.

In accordance with a further embodiment, two holders are provided that are configured to alternately transfer a carrier loaded with a portion to the movement apparatus, in particular to a transport mover or to a holding device, and to introduce a further carrier into the slice stream. The holders can in this respect in particular work alternatingly and satisfy the respective function alternately. The holders can in particular be displaceably supported on an axle. The carrier can in this manner be adjusted into a first position for loading and into a second position for the transfer to the movement apparatus. It is thereby ensured that the slices are always taken up at the same position and that the carriers are placed down at the same position. The portions on the carriers are also thereby always at the same position and do not only subsequently have to be positioned.

The carrier can in particular be movable over and/or along the holder The carrier can here preferably be moved, coming from the rear, over the holder and out of the cutting region again in the same direction. This has the advantage that the carrier is always moved in the same direction. The control has a particularly simple design in this respect. The feed of the carriers can also be integrated into the movement apparatus in a simple manner with a straight-line extent or the movement apparatus can so-to-say continue the feed without deflecting the carriers in so doing.

In accordance with a further embodiment, the carriers are introduced into the slice stream in a plane that is above a transporting away plane in which the carriers loaded with portions are moved out of the cutting region. This, for example, makes possible a narrow, compact construction since the carriers do not have to be introduced into the slice stream from the side. There is, however, always sufficient space above the transporting away plane to supply the empty carriers to the cutting region. A feed that is arranged above the transporting plane additionally has the advantage that the carriers can also be introduced into the respective slice streams with more than two tracks, which at least requires a certain construction effort with a lateral feed.

In accordance with a further embodiment, the introduction apparatus comprises a feed for the carriers that is inclined with respect to a transporting away plane. At least one component of the carriers can preferably move to the cutting region against the transporting away direction. The carriers can in particular be supplied to the cutting region obliquely from above, preferably with the slope. The carriers can in particular be produced from plastic. In this way, the carriers can slide into the cutting region or up to an introduction apparatus on the inclined feed solely due to gravity. The introduction apparatus is particularly simple in this manner. The spacing of the feed from the transporting plane in the region of the cutting region is preferably smaller than downstream viewed in the transporting away direction. The feed apparatus here so-to-say forms a wedge and can be led closely up to the cutting region without impeding the slicing unit.

In accordance with a further embodiment, the introduction apparatus is configured to introduce the carriers into the slice stream from at least one side. The carriers can preferably be inserted laterally. The carriers can in particular carry out a linear movement. The carriers can also be rotated laterally into the cutting region. The carriers can preferably be introduced into the slice stream at a right angle to the transporting away direction.

In accordance with a further embodiment, the introduction apparatus comprises a pivoting apparatus for the carriers that is pivotably supported about a pivot axis, in particular a vertical pivot axis. The carriers can in this way be pivoted into the cutting region, e.g. coming from the side. The pivot axis can preferably also be oriented obliquely to a perpendicular, i.e. the carriers carry out an oblique movement or a wobble movement.

In accordance with a further embodiment, the introduction apparatus comprises a positioning apparatus that is configured to position the carrier during an acceptance of slices, in particular to lower it, to rotate it and/or to move it in the X/Y direction relative to the slice stream.

The positioning apparatus can in particular comprise a lifting and/or rotary apparatus. The positioning apparatus can also comprise a weighing unit that weighs the portions before the transfer to the movement apparatus or to the transport movers. The positioning apparatus can in particular comprise the holder, e.g. with a movable support and/or a fork. The functionality can in this respect, for example, be integrated into the fork or into a coupling region to the holder.

The invention also relates to a method of slicing food products into portions comprising at least one slice by means of a slicing apparatus. Slices are accordingly cut from a product. The slices fall directly onto at least one carrier as a slice stream in a cutting region and form a portion on the carrier. The carriers loaded with portions are moved out of the cutting region. At least one further carrier is introduced into the slice stream as soon as a portion has been formed on a preceding carrier.

In accordance with a further embodiment, the preceding carrier is transported away with the portion while the further carrier accepts slices. There is in particular no time loss and no interruption of the slice stream in this process to be able to transport complete portions out of the cutting region.

All the embodiments of the apparatus described here are in particular configured to be operated in accordance with the method described here. Furthermore, all the embodiments of the apparatus described here as well as all the embodiments of the method described here can each be combined with one another.

The invention will be described in the following by way of example with reference to the drawings. There are shown:

FIG. 1 a side view of an embodiment of a slicing apparatus in accordance with the invention;

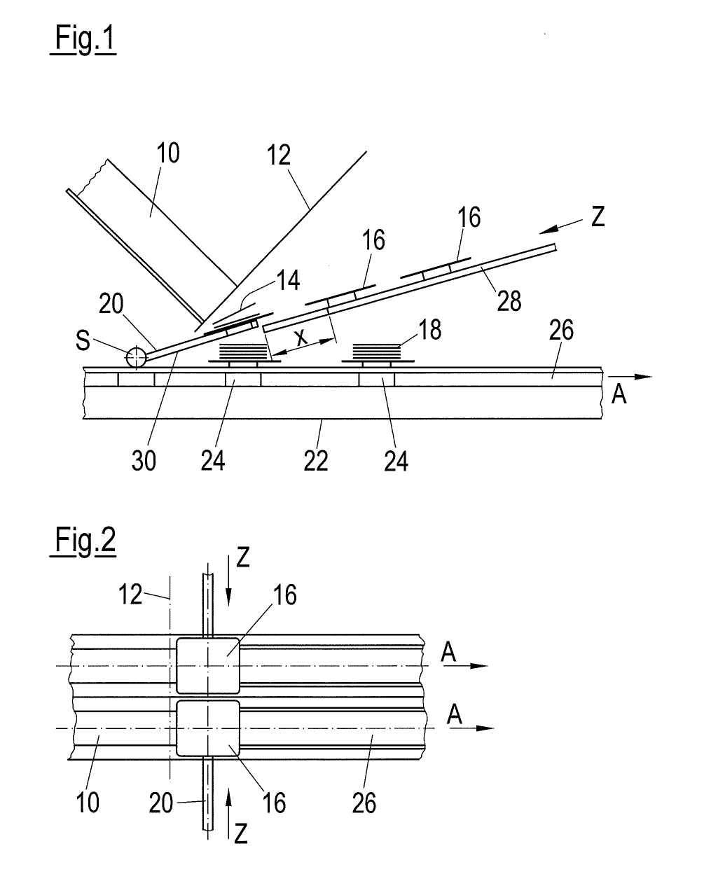

FIG. 2 to FIG. 4 plan views of further embodiments of a slicing apparatus in accordance with the invention;

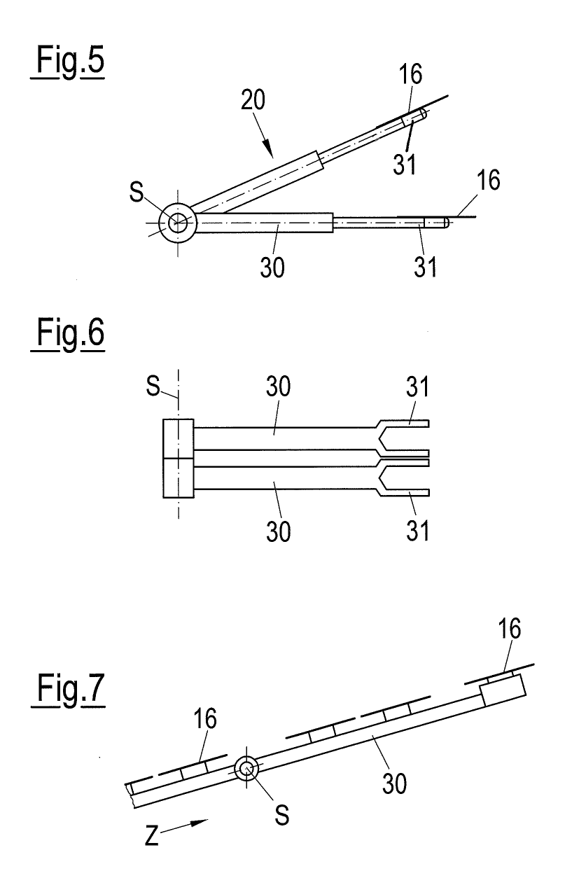

FIG. 5 a side view of an embodiment of an introduction apparatus in accordance with the invention;

FIG. 6 a plan view of the introduction apparatus of FIG. 5,

FIG. 7 a side view of an embodiment of an introduction apparatus in accordance with the invention;

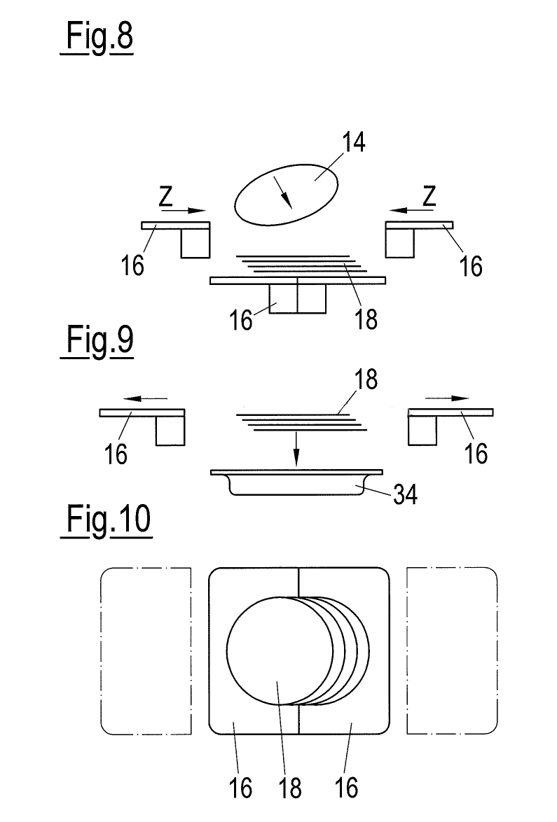

FIG. 8 and FIG. 9 side views of an embodiment of a carrier in accordance with the invention;

FIG. 10 a plan view of the carrier of FIGS. 8 and 9:

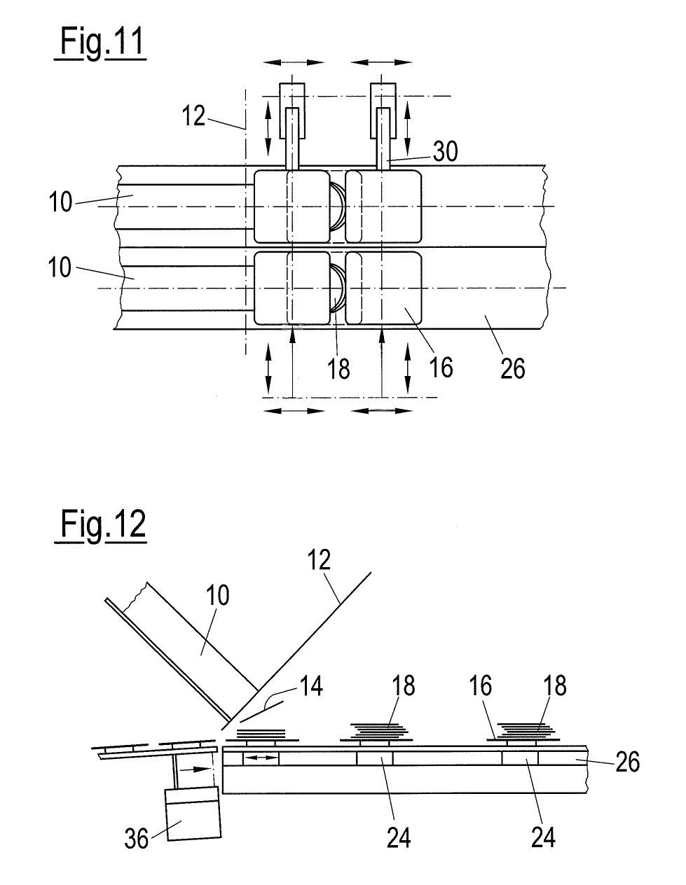

FIG. 11 a plan view of an embodiment of a slicing apparatus in accordance with the invention;

FIG. 12 a side view of an embodiment of a slicing apparatus in accordance with the invention;

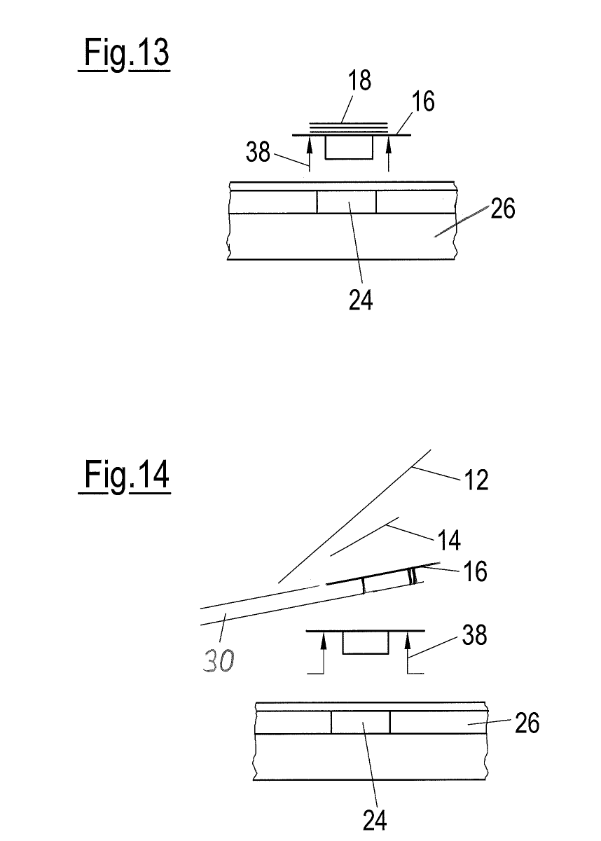

FIG. 13 and FIG. 14 side views of different embodiments of a positioning apparatus in accordance with the invention; and

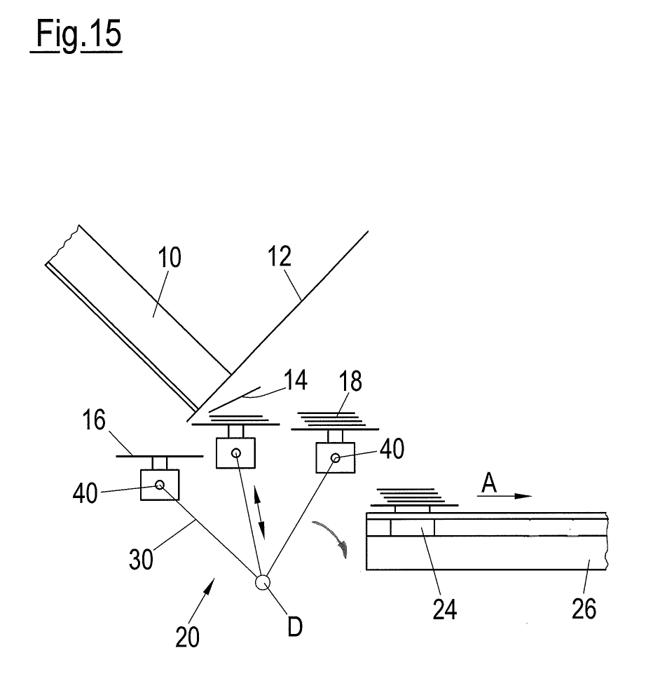

FIG. 15 a side view of an embodiment of a slicing apparatus in accordance with the invention.

It must first be noted that the embodiments shown are of a purely exemplary nature. The number of shown tracks, carriers, transport movers, holding devices and holders can in particular vary. The features of one embodiment can also be combined as desired with features of another embodiment. It is in particular also possible that a plurality of carriers arranged in parallel tracks, in particular two carriers arranged next to one another, are taken up by a common transport mover and are moved by it through the path system.

FIG. 1 shows a slicing apparatus in which a product 10 is cut into slices 14 by a slicing unit 12. The slices 14 fall directly onto a carrier 16 and form a portion 18 there.

The carriers 16 are introduced into the slice stream by an introduction apparatus 20. The carriers 16 loaded with portions 18 are subsequently moved out of the cutting region in a transporting away direction A with the aid of a movement apparatus 22.

The movement apparatus 22 has a plurality of individually movable transport movers 24 that can be moved in a path system 26.

The introduction apparatus 20 comprises an obliquely inclined feed 28 and a holder 30. The feed 28 can be adjusted by an adjustment path X at its end region facing the holder 30. The holder 30 can in turn be pivoted about a horizontal pivot axis S.

Empty carriers 16 move over the feed 28 into the cutting region in the feed direction Z and are fixed by the holder 30 there. Slices 14 are cut from the product 10 continuously and form a continuous slice stream. The slices 14 here fall directly and without impediment onto the carrier 16.

The holder 30 can be pivoted out of the inclined position about the pivot axis S into a horizontal position. The feed 28 can here be withdrawn by the adjustment path X. The freedom of movement for the holder 30 is ensured by the withdrawal or by the length variability of the free end of the feed 28.

Once a portion 18 has been prepared on the carrier 16, the holder 30 hands over the carrier 16 to the transport mover 24 of the movement apparatus 22. The transport mover 24 can wait just behind or e.g. also beneath the cutting region. The transport movers 24 can in particular be brought into the cutting region on a track-related circular path. The transport mover 24 equipped with a portion 18 is thereupon moved on the path system 26 out of the slicing region in the transporting away direction A, for example to a packaging apparatus. The track relationship is maintained here, i.e. the carrier 16 remains in a track region and the track width is not departed from on the leading away.

A further carrier 16 is moved obliquely from above via the feed 28 into the cutting region, is fixed in the holder 30, and is thus introduced into the continuous slice stream. The carrier 16 there takes up slices 14 that in turn form a portion 18 on the carrier 16.

It is made possible in this manner that completely prepared portions 18 can be transported away without the continuous slice stream having to be interrupted. The introduction apparatus 20 namely makes it possible to introduce empty carriers 16 into the continuous slice stream without having to interrupt the slice stream. It is nevertheless generally also possible to briefly interrupt the slice stream, e.g. by the carrying out of blank cuts, to obtain more time for introducing an empty carrier 16.

An oblique feed 28 is in particular advantageous in multitrack operation with at least three tracks.

If, for example, only two parallel tracks are provided, the empty carriers 16 can also, as shown in FIG. 2, be introduced or pushed into the cutting region from the side. The feed direction Z of the carriers 16 preferably extends at a right angle to the transporting away direction A.

The two carriers 16 can be taken up by a common transport mover 24 and can be transported by them. Alternatively, a separate transport mover 24 can also be associated with each carrier 16.

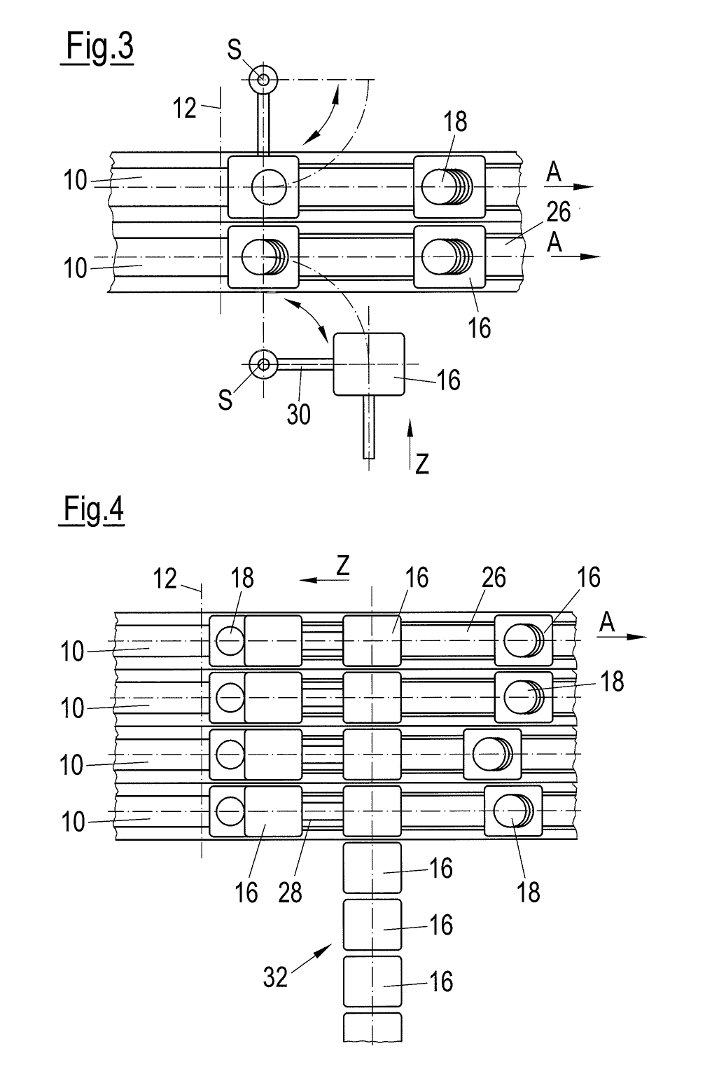

A further embodiment is shown in FIG. 3. The introduction apparatus 20 can in this respect be pivoted about an at least substantially vertical pivot axis S. The carriers 16 are accordingly rotated laterally into the cutting region, preferably at a right angle to the transporting away direction A.

The pivot axis S can also be inclined with respect to the vertical. This is in particular advantageous when the carriers 16 are introduced into the cutting region on an obliquely inclined feed 28 such as is shown in FIG. 1, for example. The rotating in of the empty carriers 16 can take place above completed portions 18 in this case.

The holder 30 can preferably vertically adjustable, in particular lowerable. For this purpose, the holder 30 can e.g. comprise a telescopic arm extending along the pivot axis S.

Alternatively or additionally, the holder 30 can comprise a fork 31, tong and/or clip, in particular controllable, at the region in which the carrier 16 is fixed. The fork 31 can preferably be opened and closed to fix the carrier 16 at least temporarily to the holder 30.

It is advantageous if the carrier 16 is introduced laterally into the fork 31 since then the fork opening already faces in the transporting away direction A after an inward pivoting so that the carrier 16 can be transferred to a transport mover 24 in a simple manner.

The carrier 16 can be introduced into the slice stream laterally or from below. The carrier 16 can also fall from a feed 28 into the holder 30, in particular into the fork 31.

With a single-track or two-track slicing apparatus, the track width does not necessarily play a role for the movement of the carrier 16. The carrier 16 can be led in or out both obliquely from above and from the side, e.g. via a rotating and/or pivoting movement.

With the slicing apparatus that is shown in FIG. 4, the empty carriers 16 move in a plane above the transporting away plane via a distributor 32 to the feed 28. This can be obliquely inclined, as shown in FIG. 1. A plurality of parallel feeds 28 can be equipped with empty carriers 16 by the distributor 32. The carriers 16 move over the oblique feeds 28 into the cutting region and are transferred to the holders 30. In a transporting away plane disposed thereunder, the carriers 16 equipped with portions 18 can subsequently be transported away out of the cutting region in the transporting away direction A.

The feed from above is advantageous since there is sufficient construction space available above the transporting away plane. The distributor 32 and the introduction apparatus 20 consequently do not require any additional space. This embodiment is particularly advantageous in a multitrack operation. The method shown is, however, generally also usable with only a single track.

The loading of the carriers 16 with slides 14 can take place synchronously in the tracks. It is, however, also generally possible that the carriers 16 are loaded with slices 16 and transported away independently of one another.

An introduction apparatus 20 is shown in FIGS. 5 and 6. The introduction apparatus 20 has two holders 30 that can, for example, work alternately. A holder 30 can thus hand over a carrier 16 with a completed portion 18 to the movement apparatus 22 while the other holder 30 picks up a subsequent carrier 16 in the fork 31.

The holder 30 can in particular also be longitudinally adjustable to expel the carriers 16 toward the front to the movement apparatus 22.

The fork 31 can in particular be open toward the feed direction and/or removal direction, preferably at the front or laterally. The holder 30 can preferably correspond to a corresponding receiver at a lower side of the carrier 16.

The holder 30 can in particular be lowered, preferably in dependence on the portion height.

The holder 30 can also carry out an X/Y movement, for example. In this manner, longitudinally and transversely overlapping portions can be prepared on the carrier 16.

The holder 30 can, however, not only e.g. be adjusted longitudinally. It is thus, for example, also possible to configure the head, in particular the fork 31, of the holder 30 as rotatable in order, for example, to be able to receive carriers 16 laterally.

The holding devices 30 can also each be axially displaceable along the pivot axis S to move the carriers 16 into the track center. They can thus provide a transverse movement of the carriers 16 for the portion formation. The portions 18 on a carrier 16 of the left or right holder 30 would otherwise always be positioned offset from one another and would later have to be brought onto a common track axis.

In accordance with the embodiment that is shown in FIG. 7, the carriers 16 can also be moved over or along the holder 30. No direct feed, timed supply or transfer is necessary. Nor is a change of direction required. The carriers 16 can thus be fed in and transported away along a single direction. This principle is conceivable for a holder 30 that is pivoted at the feed side, at the removal side or also laterally with respect to a track.

It is sufficient here if a new, empty carrier 16 is always subsequently conveyed into the cutting region in an end position of the holder 30, preferably in the oblique position before the handing over of the carrier 16.

It is shown in FIGS. 8 to 10 that two carriers 16 can also be provided for a single portion 18. These carriers 16 can be introduced into the slice stream from the side. This in particular has the advantage that the carriers 16 can be introduced faster into the continuous slice stream of the falling slices.

As can be seen in FIG. 9, a portion 18 conveyed on the carriers 16 can also be handed over into a packaging 34 in a simple manner. The carriers 16 are here separated from one another above the packaging 34 so that the portion 18 can fall down. This can, for example, take place at the end of a track system 26. The portion 18 is subsequently located in a packaging depression, e.g. in a tray.

In the embodiment in accordance with FIG. 11, a plurality of holders 30 are each arranged laterally next to a track. These holders 30 provide the feed of the empty carriers 16 and can be moved in the X direction and in the Y direction.

In the embodiment shown in FIG. 12, the empty carriers 16 can be introduced into the cutting region via a timed supply unit 36 beneath a cutting edge. The carriers 16 can here already be connected to a transport mover 24 or can be transported into the cutting region in a different manner, e.g. via a conveyor belt. In the cutting region, the transport movers can be moved forward and backward as desired with the carrier 16 to prepare a desired placement pattern. This cutting region in which the portions are prepared can also be arranged separately from the path system 26 which provides the transporting away.

A positioning apparatus 38 is symbolically indicated by the arrows in FIGS. 13 and 14. The introduction apparatus 20 can thus comprise a positioning apparatus 38 in these embodiments that provides a lifting and/or rotary movement of the carriers 16. The positioning apparatus 38 is active before the carriers 16 are transferred to the transport movers 24. The positioning apparatus 38 can also rotate the carriers 16 to arrange the slices 14 in a circle, for example.

The positioning apparatus 38 can furthermore comprise a scale, for example, to weigh the portion 18 in this step.

The positioning apparatus 38 can detect the carrier 14 from the outside and can guide it. The positioning apparatus 38 can also lower the carrier 16 and transfer it to the transport mover 24 waiting underneath. It is conceivable here that the carrier 16 is dropped into a holding device of the transport mover 24 with the help of gravity.

The handling of the slices 14 or of the portions 18 thus takes place in three planes so-to-say. The holder 30 for the carriers 16 is provided in the topmost plane. The start of the portion preparation takes place in this plane. The positioning apparatus 38 that handles the completed portions 18 is arranged in the middle plane. The transport movers 24 finally wait in the bottommost plane and provide the transporting away of the carriers 16.

In the embodiment in accordance with FIG. 15, the introduction apparatus 20 comprises a rotary apparatus. A plurality of holders 30 are rotatably arranged about an axis of rotation D here. The carriers 16 can, figuratively speaking, be moved as with a Ferris wheel and can be introduced into the cutting region after one another. A rotary joint 40 at the respective end region of the holders 30 provides that the carriers 16 are always horizontally oriented.

The holders 30 can be longitudinally adjustable. It is also conceivable that the respective holders are vertically adjustable. The carriers 16 can preferably carry out an X/Y movement and/or a rotary movement due to the holders 30.

The rotary apparatus can in particular be arranged laterally next to the track or next to the movement apparatus 22. Two rotary apparatus having a common axis of rotation D can be provided for each track and feed carriers 16 alternately into the cutting region. This can take place from one side or from both sides. The portions 18 can also be weighed prior to the transfer to the transport mover 24.

Blank cuts can thus be avoided in accordance with the invention. The apparatus does not require any equipment for this purpose, i.e. the slicing unit dos not have to have any disengagement mechanism or the like for this purpose. The product 10 also does not have to be moved against the feed direction. Since the slices 14 fall directly onto the carriers 16 and no longer have to be removed from them up to the packaging apparatus, a high portion quality is achieved. The portion build-up is namely not negatively influenced by possible belt transitions during the transport.

A high cutting power can be ensured in accordance with the invention since the slice stream is not interrupted by blank cuts.

### REFERENCE NUMERAL LIST

10 product
12 slicing unit
14 slice
16 carrier
18 portion
20 introduction apparatus
22 movement apparatus
24 transport mover
26 path system
28 feed
30 holder
31 fork
32 distributor
34 packaging
36 timed supply unit
38 positioning apparatus
40 rotary joint
A transporting away direction
Z feed direction
X adjustment path
S pivot axis
D axis of rotation

1. A high-speed slicer apparatus for slicing food products into portions, comprising: at least one slice, having a slicing unit that is configured to cut slices from a product, wherein the slices fall directly onto at least one carrier as a slice stream in a cutting region and form a portion on the carrier;
a movement apparatus for moving the carriers loaded with portions out of the cutting region;
an introduction apparatus that is configured to introduce at least one further carrier into the slice stream as soon as a portion has been formed on a preceding carrier; and
at least one control device for controlling the movements of the carriers, the slicing unit and/or the introduction apparatus.

2. The apparatus of claim 1, wherein
the slicing unit is configured to cut slices continuously from a product, with the slice stream being continuous.

3. the apparatus of claim 1 wherein
the movement apparatus comprises a plurality of individually movable transport movers and a path system for the transport movers in which the transport movers are movable along at least one predefined path in a transporting away direction, with the transport movers in particular each comprising at least one runner cooperating with the path system and a holding device for receiving at least one carrier at the runner.

4. The apparatus of claim 1 wherein
the control device controls the slicing unit such that no blank cuts are carried out.

5. The apparatus of claim 1 wherein
the control device controls the slicing unit such that the spacing between falling slices of a product is constant.

6. The apparatus of claim 1 wherein
a transfer apparatus is provided that transfers the portion from the carrier to a packaging apparatus.

7. The apparatus of claim 1 wherein
the portion remains on the carrier up to the transfer to a packaging apparatus.

8. The apparatus of claim 1 wherein
two carriers are provided for each portion and complement one another in the cutting region to form a common support for the portion.

9. The apparatus of claim 1 wherein
the introduction apparatus comprises at least one holder that temporarily fixes the carrier.

10. The apparatus of claim 9 wherein
the holder is configured to transfer the carrier loaded with a portion to the movement apparatus, in particular to a transport mover or to a holding device.

11. The apparatus of claim [symbol] , wherein
two holders are provided that are configured to alternately transfer a carrier loaded with a portion to the movement apparatus, in particular to a transport mover or to a holding device, and to introduce a further carrier into the slice stream.

12. The apparatus of claim 1 wherein
the carriers are introduced into the slice stream which is above a transporting away plane in which the carriers loaded with portions are moved out of the slicing region.

13. The apparatus of claim 1 wherein
the introduction apparatus comprises a feed for the carriers inclined with respect to a transporting away plane.

14. The apparatus of claim 1 wherein
the introduction apparatus is configured to introduce the carriers into the slice stream from at least one side.

15. The apparatus of claim 1 wherein
the introduction apparatus comprises a pivoting apparatus for the carriers that is supported pivotably about a pivot axis, in particular about a vertical pivot axis (S).

16. The apparatus of claim 1 wherein
the introduction apparatus comprises a positioning apparatus that is configured to position the carrier during an acceptance of slices, in particular to lower it, to rotate it and/or to move it in the X/Y direction relative to the slice stream.

17. A method for slicing food products into portions, using the apparatus of claim 1, comprising: making at least one slice using the slicing apparatus;
in which slices are cut from a product;
wherein the slices fall directly onto at least one carrier as a slice stream in a cutting region and form a portion on the carrier;
wherein the carriers loaded with portions are moved out of the cutting region; and
at least one further carrier is introduced into the slice stream as soon as a portion has been formed on a preceding carrier.

18. The method of claim 17 wherein
the preceding carrier (16) is transported away with the portion (18) while the further carrier (16) receives slices (14).
